(19) United States
(12) Patent Application Publication
(10) Pub. No.: US 2026/0050263 A1
(43) Pub. Date: Feb. 19, 2026

(54) METHOD AND SYSTEM FOR EXPLORING A REAL-WORLD ENVIRONMENT

(71) Applicant: Dyson Technology Limited, Malmesbury, Wiltshire (GB)

(72) Inventors: Robin Gregory READ, Bristol (GB); Jan Robert Mieczyslaw JACHNIK, Swindon (GB); Martin TOSAS BAUTISTA, Bristol (GB); Andre MOUTON, Bath (GB); Charles Anthony Neild COLLIS, Bath (GB)

(21) Appl. No.: 19/101,924

(22) PCT Filed: Aug. 8, 2023
(86) PCT No.: PCT/IB2023/058001

§ 371 Date: Feb. 7, 2025

(30) Foreign Application Priority Data
Aug. 10, 2022 (GB) 2211685.9

(51) Int. Cl. G05D 1/246; G05D 1/656; G05D 101/15; G05D 101/20

(52) U.S. Cl. CPC G05D 1/2464; G05D 1/656; G05D 2101/15; G05D 2101/20

(57) ABSTRACT

A method and system for exploring a real-world environment using a mobile robot platform comprising mapping the environment at a first time, to generate a first representation of the environment and identifying an initial location of an object in the first representation of the environment. The environment is mapped at a second time, to generate a second representation of the environment. The mappings are generated based on data obtained from a sensor associated with the mobile robot platform. Based on data obtained from the sensor, a new location of the object is identified in the second representation of the environment, and a difference between the initial location of the object and the new location of the object is determined. Using a manipulator the object is moved to the initial location when it is determined that the initial location of the object differs from the new location.

### FIELD OF THE INVENTION

The present invention relates to a method and system for exploring a real-world environment. More particularly, but not exclusively, the method and system, relate to exploring a real-world environment using a mobile robot platform.

### BACKGROUND OF THE INVENTION

Robotic devices are able to map, and navigate in, a real-world environment using a sensor system. Processing the data from the sensor system is a computationally complex and resource-intensive process, and therefore exploring the real-world environment fully can take a long time. This is further compounded by objects within the real-world environment obstructing the robotic device and being moved from their desired location making the exploration of the real-world environment by the robotic device even more complicated.

### SUMMARY OF THE INVENTION

According to a first aspect of the present invention, there is provided a method for exploring a real-world environment using a mobile robot platform, the method comprising mapping the real-world environment at a first time, to generate a first representation of the real-world environment at the first time based on data obtained from at least one sensor associated with the mobile robot platform, and identifying an initial geographic location of an object in the first representation of the real-world environment; mapping the real-world environment at a second time, later than the first time, to generate a second representation of the real-world environment at the second time based on data obtained from the at least one sensor associated with the mobile robot platform, and identifying a new geographic location of the object in the second representation of the real-world environment; determining a difference between the initial geographic location of the object and the new geographic location of the object; and using a manipulator associated with the mobile robot platform to move the object to the initial geographic location in the real-world environment when it is determined that the initial geographic location of the object differs from the new geographic location of the object. This enables the locations of objects to be tracked, such that if they are moved from a desired, initial, geographical location, to a new geographical location, the mobile robot platform can use the manipulator to move the object back to the initial geographical location. Furthermore, by mapping the environment at different times, it can be determined in real-time, whether an object has been moved from its initial geographical location and take actions to move the object back quickly and efficiently.

Mapping the real-world environment at the first time and mapping the real-world environment at the second time may comprise identifying at least one of a surface within the real-world environment on which the object is placed; and a storage receptacle in the real-world environment containing the object. By identifying surfaces and storage receptacles, such as cupboards or storage boxes, an object may be associated with said surface or storage receptacle, and when it is determined that the object has been moved to a different surface and/or moved from its storage receptacle it may be moved back.

In examples, mapping the real-world environment at the first time and mapping the real-world environment at the second time comprises analysing the data obtained from at least one sensor associated with the mobile robot platform using at least one of a frontier exploration methodology and a contour exploration methodology. By using frontier exploration and/or contour exploration the real-world environment may be efficiently and quickly mapped, and the geographical location of objects within the environment may be identified. Furthermore, each of the methodologies enables the mapping of the real-world environment to be undertaken whilst exploring the environment.

Mapping the real-world environment at the first time may comprise analysing the data obtained from the at least one sensor associated with the mobile robot platform to identify and classify the object in the first representation. Furthermore, the classification of the object in the first representation may be based on a database of known objects retrieved from storage associated with the mobile robot platform, and/or based on an analysis of the data obtained from the at least one sensor using a machine learning methodology. By identifying and classifying objects with the first representation, one or more characteristics of those objects can be determined and when using the manipulator to move the object back to the initial geographic location, the manipulator can be configured to handle the object in a predetermined way, therefore ensuring the object is handled correctly.

In examples, the method comprises determining whether the object is a moveable object based on the classification of the object, and when it is determined that the object is not a moveable object flagging said object in the first representation as immoveable. Determining whether an object is moveable or not and flagging it accordingly, enables the mobile robot platform to identify immoveable objects quickly and efficiently, and prevents the manipulator from attempting to move immoveable objects.

The method may comprise storing at least the first representation of the real-world environment in storage associated with the mobile robot platform. This enables the first representation to be received quickly and efficiently at a later time, such that a desired initial geographic location for the objects in the real-world environment can be saved.

In examples, mapping the real-world environment at the first time and at the second time includes determining a pose of the object in the respective representation of the real-world environment and using the manipulator to move the object to the initial geographic location in the real-world environment includes restoring a pose of the object to that at the first time.

In examples, using a manipulator associated with the mobile robot platform to move the object to the initial geographic location in the real-world environment is performed when it is determined that the initial geographic location of the object differs from the new geographic location of the object by more than a threshold amount. Small displacements in location and/or pose may therefore not result in action to restore the location and/or pose of the object.

According to a second aspect of the present invention, there is provided a system for exploring a real-world environment, the system comprising at least one sensor to capture information associated with the real-world environment; an manipulator to move an object in the real-world environment; and at least one processor to map the real-world environment at a first time, to generate a first representation of the real-world environment at the first time based on data obtained from the at least one sensor, and identify an initial geographic location of the object in the first representation of the real-world environment; map the real-world environment at a second time, later than the first time, to generate a second representation of the real-world environment at the second time based on data obtained from the at least one sensor, and identify a new geographic location of the object in the second representation of the real-world environment; determine a difference between the initial geographic location of the object and the new geographic location of the object; and control the manipulator to move the object to the initial geographic location in the real-world environment when it is determined the initial geographic location of the object differs from the new geographic location of the object. This enables the locations of objects to be tracked, such that if they are moved from a desired, initial, geographical location, to a new geographical location, the mobile robot platform can use the manipulator to move the object back to the initial geographical location. Furthermore, by mapping the environment at different times, it can be determined in real-time, whether an object has been moved from its initial geographical location and take actions to move the object back quickly and efficiently.

In examples, the system comprises a locomotion-enabled component for navigating to a given geographical location in the real-world environment, wherein the given geographical location is associated with at least one of the initial geographic location of the object, and the new geographic location of the object. This enables the system to be positioned at and moved between various locations in the real-world environment to enable objects at those different locations to be moved to their initial, desired, geographical location.

The system may comprise storage for storing at least the first representation of the real-world environment. This enables the first representation to be received quickly and efficiently at a later time, such that a desired initial geographic location for the objects in the real-world environment can be saved.

In examples, the manipulator comprises a robotic system for manipulating the object. This enables the object to be manipulated, such as grabbed, held, and transported around the real-world environment, such that the object can be moved between various geographical locations within the real-world environment.

In examples, the at least one sensor for capturing information associated with the real-world environment comprises at least one of a camera unit; a time of flight sensor unit; an array distance sensor unit; and an inertial measuring unit. Using different sensors enables differing information to be gathered and processed, and therefore can be used to generate more accurate and comprehensive mappings of the real-world environment.

In examples, the at least one sensor is a moveable sensor configured to scan the real-world environment to increase the field-of-view of the at least one sensor. This enables the sensor to move such that it can be repositioned as required to increase its field of view and therefore gather more data about the real-world environment.

According to a third aspect of the present invention, there is provided a non-transitory computer-readable storage medium comprising a set of computer-readable instructions stored thereon which, when executed by at least one processor are arranged to explore a real-world environment using a mobile robot platform, the instructions, when executed, cause the processor to map the real-world environment at a first time, to generate a first representation of the real-world environment at the first time based on data obtained from at least one sensor associated with the mobile robot platform, and identifying an initial geographic location of an object in the first representation of the real-world environment; map the real-world environment at a second time, later than the first time, to generate a second representation of the real-world environment at the second time based on data obtained from the at least one sensor associated with the mobile robot platform, and identifying a new geographic location of the object in the second representation of the real-world environment; determine a difference between the initial geographic location of the object and the new geographic location of the object; and use a manipulator associated with the mobile robot platform to move the object to the initial geographic location in the real-world environment when it is determined that the initial geographic location of the object differs from the new geographic location of the object. This enables the locations of objects to be tracked, such that if they are moved from a desired, initial, geographical location, to a new geographical location, the mobile robot platform can use the manipulator to move the object back to the initial geographical location. Furthermore, by mapping the environment at different times, it can be determined in real-time, whether an object has been moved from its initial geographical location and take actions to move the object back quickly and efficiently.

Further features and advantages of the invention will become apparent from the following description of preferred examples of the invention, given by way of example only, which is made with reference to the accompanying drawings. Optional features of aspects of the present invention may be equally applied to other aspects of the present invention, where appropriate.

### BRIEF DESCRIPTION OF THE DRAWINGS

FIG. 1 is a flowchart illustrating a method of exploring a real-world environment using a mobile robot platform, according to an example;

FIG. 2 is a flowchart illustrating a contour exploration method of mapping a real-world environment using a mobile robot platform, according to an example;

FIG. 3A is a schematic diagram of an occupancy grid representing a first mapping of a real-world environment, generated using a mobile robot platform, according to an example;

FIG. 3B is a schematic diagram of an occupancy grid representing a second mapping of a real-world environment, generated using a mobile robot platform according to an example;

FIG. 4 is a schematic diagram of a distance map generated by the mobile robot platform according to an example;

FIG. 5A is a schematic diagram of a refined distance map indicating a plurality of contours according to an example;

FIG. 5B is a schematic diagram of the refined distance map of FIG. 5A where the plurality of contours have associated waypoints; and

FIG. 6 is a block diagram of a system for mapping a real-world environment according to an example.

### DETAILED DESCRIPTION

Details of methods and systems according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are illustrated schematically with certain features omitted and/or necessarily simplified for the ease of explanation and understanding of the concepts underlying the examples.

According to examples herein, determining whether objects in a real-world environment have moved over time requires an accurate map of the real-world environment at a first time, and an accurate map of the real-world environment at a second, subsequent time. Accurately mapping a real-world environment using a robot can be a time consuming and processor-intensive operation, which is dependent on a number of factors, including the complexity of the real-world environment, the presence of objects within the real-world environment, and the capability of the hardware used to map the real-world environment.

### Determining Changes and Moving Objects in the Real-world Environment

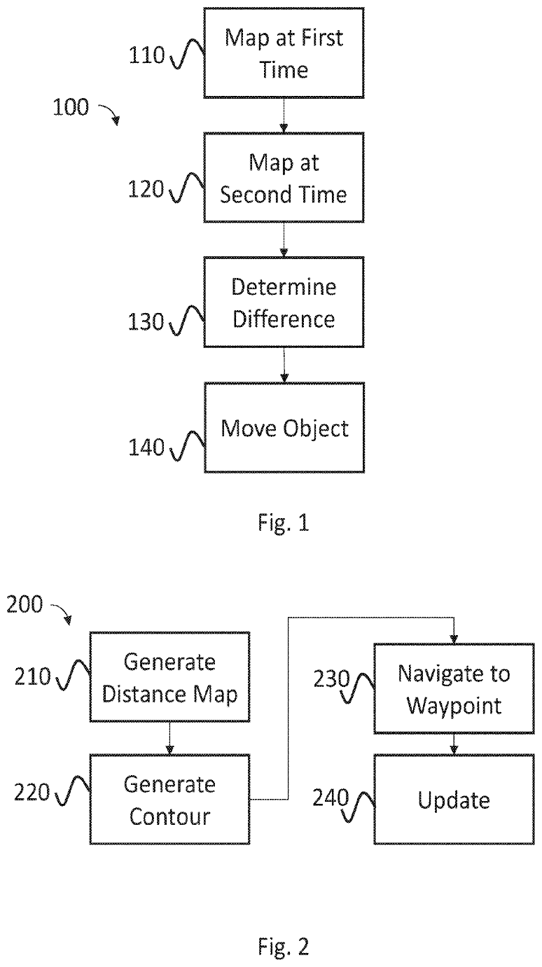

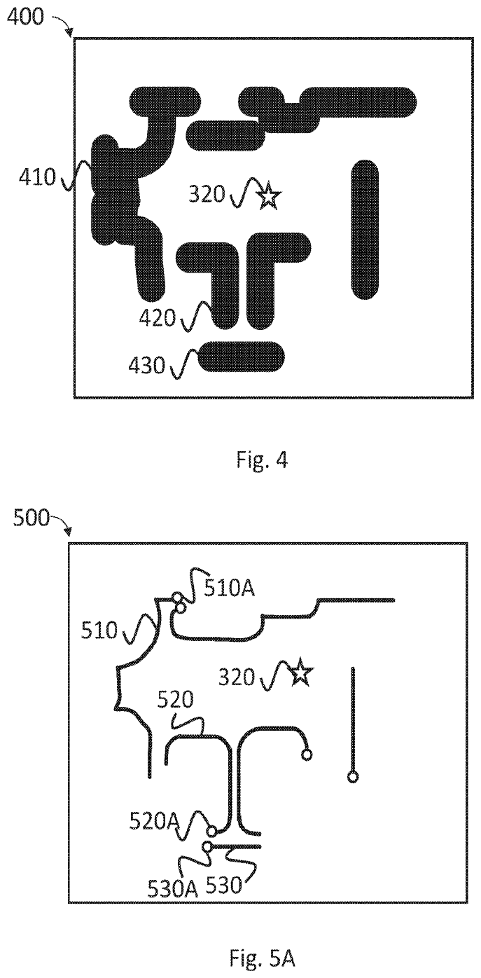

FIG. 1 shows a flowchart showing a method 100 in accordance with an example. The method 100 maps a real-world environment at a first and second, subsequent. It will be appreciated that multiple different methodologies for mapping the real-world environment may be used including, but not limited to, a frontier exploration methodology and a contour exploration methodology, as will be described in further detail below with reference to FIGS. 2-5B.

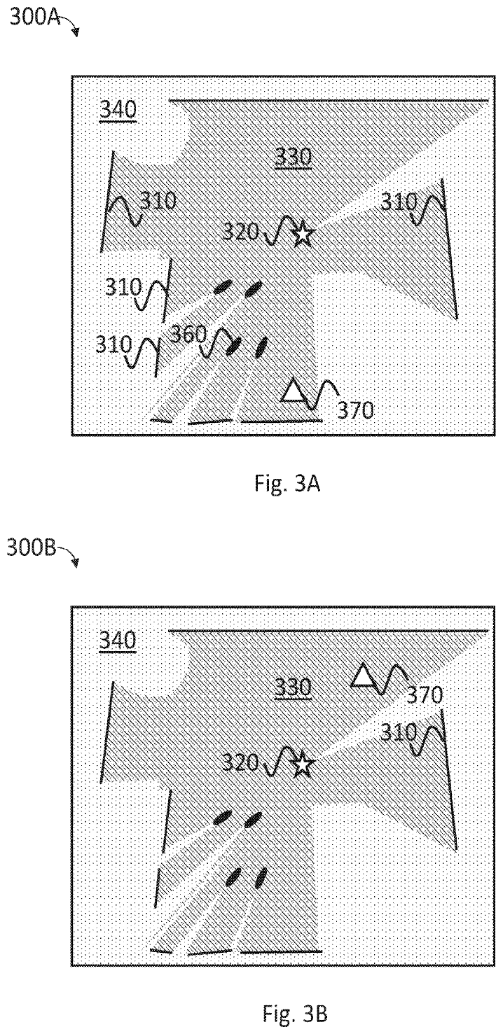

At step 110 of method 100 the real-world environment is mapped at a first time. Mapping the real-world environment at the first time may be in response to a user command, and/or may be undertaken as part of the initialisation of a system, such as system 600 described below. Mapping the real-world environment at the first time generates a first representation of the real-world environment at the first time, such as representation 300A shown in FIG. 3A. The representations generated during the mapping process may be topographical (i.e., two-dimensional) or geometric (i.e., three-dimensional). The mapping of the real-world environment is undertaken by a mobile robot platform, and data is obtained from one or more sensors associated with the mobile robot platform as it navigates the real-world environment. The mobile robotic system may have no prior knowledge of the environment before this initial mapping. Further details will be described below with reference to FIG. 6.

In some examples, as part of the mapping process to generate the first representation 300A, the data obtained from the one or more sensors associated with the mobile robot platform may be analysed to identify and/or classify objects within the real-world environment, such as object 370. The identification and/or classification of the objects may be undertaken using a number of methodologies which includes analysing the data obtained from the one or more sensors associated with the mobile robot platform. Analysing the data from the one or more sensors to classify objects in the first representation 300A may comprise comparing the data to data within a database of known objects. The database may be stored remotely and/or may be part of the mobile robot platform. In other examples, classifying objects in the data from the one or more sensors may comprise providing the data as an input to a machine learning model, which has been trained to identify and classify objects. Following the identification and/or classification of the objects within the data obtained from the one or more sensors, it may be determined whether the identified object 370 is a moveable object. For example, the analysis may be used to identify large objects in the real-world environment, such as a table or chair in a habitable room. Whilst such objects are technically moveable, they may not be able to be moved by the mobile robot platform, and as such would be categorised as immovable objects for the present purposes. Conversely, the mobile robot platform may be capable of moving smaller objects such as crockery and/or cutlery, toys, items of clothing, print media, and others. In some examples, the mobile robot platform may interact with the identified object 370 to determine whether it is moveable. In some cases, the identified object 370 may be small enough to be moved by the mobile robot platform, however, the identified object 370 may be secured to a surface and as such be immoveable. As such, these objects may be flagged as a moveable object according to the capabilities of the mobile robot platform.

The first representation 300A, therefore, represents a ground truth of the location of objects, obstacles, and surfaces within the real-world environment, such as object 370. This is used to indicate the desired or preferred geographic location of said object 370 within the real-world environment. This is referred to herein as a ‘tidy’ state, and is a preferred object map. In some examples, the first representation 300A, along with any data determined regarding objects in the real-world environment, such as their geographical locations, may be stored in storage associated with a system. Other information relating to the objects may be stored in the storage, such as a pose of an object, capturing the orientation of the object in addition to its location. In some examples, the initial pose of the object may be a preferred state, such that it is the desired orientation of the object when in the ‘tidy’ state. The locations of the objects in the first representation may represent a complete representation of the objects (that is, the entire real-world environment of interest has been observed), or may be a partially complete representation (that is, when the real-world environment has been sufficiently but only partially observed). The storage may be local to the system or remote such that the first representation 300A is uploaded to storage associated with a remote server via a wired or wireless network connection, including but not limited to 802.11, Ethernet, Bluetooth®, or near-field communications (‘NFC’) protocol.

Once the real-world environment has been mapped at the first time, and the first ‘ground truth’ representation 300A has been generated, the method 100 proceeds to step 120 where the real-world environment is mapped at a second, subsequent time. The mapping of the real-world environment at the second, subsequent time, may be undertaken automatically, such as at predetermined times, and/or may be undertaken in response to user input, indicating that the mobile robot platform is to perform a further mapping. The mapping at the second, subsequent time, results in a second representation of the environment being generated, such as representation 300B in FIG. 3B, as a result of the data obtained from one or more sensors associated with the mobile robot platform. This is representative of a current object map. Furthermore, the mapping at the second, subsequent time may reuse part of the first representation 300A, for example, for the purpose of determining a location of the mobile robotic platform in the real-world environment. The second representation 300B comprises data representative of objects, obstacles, and surfaces in the real-world environment, such as the new geographical location of the object 370 within the real-world environment. In the example of FIG. 3B, as the object 370 is no longer in the same geographic location as in the first representation 300A, this second representation 300B is referred to herein as an ‘untidy’ state. Such data regarding the objects may be identified and classified as described above with reference to step 110.

When generating the first representation 300A and second representation 300B as part of the mapping process described above with reference to steps 110 and 120, a number of features of the real-world environment may be identified. For example, when identifying the objects in the real-world environment, the mapping process may comprise identifying a surface on which the object is placed, and/or a storage receptacle which contains the object. By detecting such surfaces/storage receptacles, as discussed below, an accurate geographical location relative to such surfaces/storage receptacles can be determined. For example, where a desired location for a given object is in a cupboard in the real-world environment, by identifying said cupboard and associating the object with it when performing the first mapping, it can be determined in the second, subsequent, mapping whether the object is no longer in its desired location, that is in the cupboard.

Once the real-world environment has been mapped at the second, subsequent time, and the second representation 300B has been generated, the method 100 proceeds to step 130, where it is determined whether any of the objects have moved. The identification of discrepancies to determine whether any of the objects have moved between the first time, that being the time the first representation 300A was generated, and the second time, being the time that the second representation 300B was generated, involves comparing the first 300A and second 300B representations. Data associated with each object, such as object 370, in the representations 300A, 300B can be obtained so as to determine whether the geographical location of the object 370 in the first representation 300A, that being the initial, desired location, is different from the new geographical location of the object 300B in the second representation 300B. Furthermore, data can be obtained to identify whether the position and pose of the object 370 is different in the second representation 300B, within a given allowable threshold. The threshold may be determined using any number of methods, such as by calculating a Euclidean distance between the position/pose in the first representation 300A and the position/pose in the second representation 300B. In examples, the threshold is set so that relatively small changes in location and/or pose (for instance by a few centimetres/degrees) are not consisted significant enough to warrant attention. In some cases, the object 370 will not have moved, and therefore the initial geographic location will be the same as the new geographic location. In other cases, such as in the example in FIGS. 3A and 3B, the object 370 will have moved, and, as such, the initial geographic location will differ from the new geographic location. In still other cases, the object may not have been moved geographically but its pose may have been altered.

Once it has been determined whether the object in the real-world environment has moved location and/or pose, for example by more than the allowable threshold, the method 100 proceeds to step 140, where, based on the previous determination, the object 370 is moved or restored autonomously from the new geographic location back to the initial geographic location and/or pose. The geographic location/pose accuracy with which the object is restored may also be determined to be within a threshold, for example similar to the first-mentioned threshold. Restoring the location and pose approximately, for example to within the threshold, permits the process to complete more quickly than would be the case if greater location/pose accuracy were required, where there is a natural trade-off between speed of operation and accuracy.

It will be appreciated that there are numerous methods of moving the object 370, including the use of a manipulator, such as a grabbing mechanism, associated with the mobile robot platform. The manipulator may be configured to grab the object 370, after which the mobile robot platform moves to a geographic location in the real-world environment close to the initial geographic location. This enables the manipulator to place the object 370 back at the initial geographic location. As described above, in some examples, the object 370 may be associated with a given surface or storage receptacle in the real-world environment. In such examples, the object 370 may be placed within the storage receptacle or on the given surface. This may require the use of additional manipulator, such as another grabbing mechanism in order to open any storage receptacle as required. Alternatively, in other examples, the mobile robot platform may be configured to put the object in a geographical location nearby, such that it can use the manipulator to open the receptacle before returning to the object and moving it to the storage receptacle. In addition to moving objects autonomously back to their preferred location, the mobile robotic system may, in some examples, identify further discrepancies between the first representation 300A (that is, the tidy state) and the second representation (that is, the current, possibly untidy state). In some examples, the mobile robot platform may comprise an on-board storage receptable for storing objects to be moved. This enables the mobile robot platform to move multiple objects at the same time, by storing them in the on-board storage receptacle whilst traversing to the preferred location.

In yet further examples, the mobile robot platform may comprise a swarm of robots each capable of mapping and/or manipulating and relocating objects in the real-world environment.

### Mapping Methodologies

One methodology for mapping real-world environments is frontier exploration. Frontier exploration comprises obtaining data from one or more sensors of the mobile robot platform, defining the border between known and unknown space based on the field of view of the sensor, and repeatedly moving towards them until no more frontiers are determined. This ensures that there are no unknown regions in the generated map.

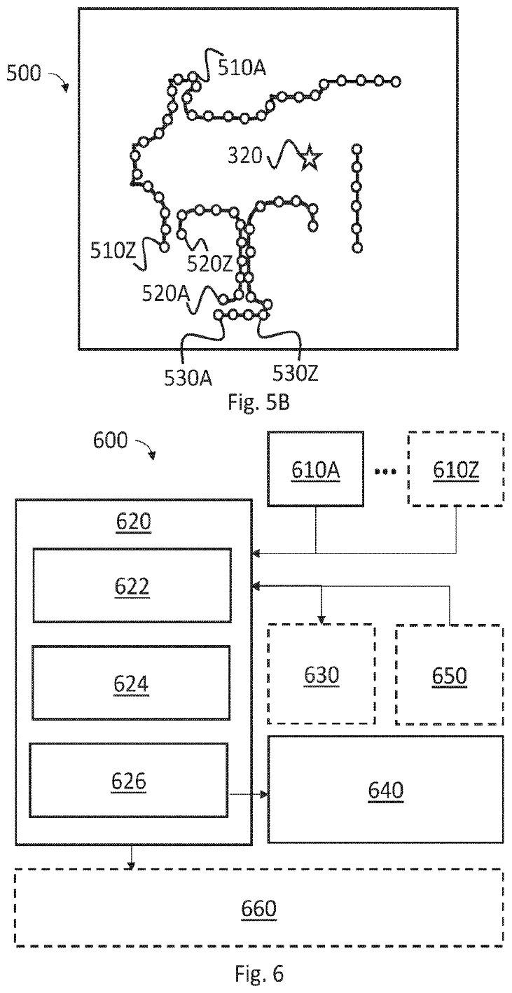

Another methodology for mapping real-world environments is contour exploration, which comprises the detection of objects within the field of view of one or more sensors of the mobile robot platform, and systematically moving around them to obtain further information about the real-world environment. An example of the contour exploration will now be described with reference to FIGS. 2-5A. FIG. 2 is a flowchart showing a mapping method 200 in accordance with an example. The mapping method 200 maps a real-world environment using a mobile robot platform, such as the mobile robot platform described below with reference to FIG. 5. The mapping method 200 will also be described with reference to representations 300, 400, 500 of an exemplary real-world environment shown in FIGS. 3-5B. Whilst a given real-world environment is shown in FIGS. 3-5B, it will be appreciated that the mapping method 200 may be applied to any given real-world environment, and different representations generated. Although the mapping method 200 is described with reference to a contour exploration methodology, it will be appreciated that other methodologies, such as frontier exploration may be used in other examples, as described above.

At step 210 of the mapping method, a distance map is generated. The distance map is generated based on an occupancy grid, such as the occupancy grid 300 shown in FIG. 3A. The occupancy grid 300 is a representation of a given real-world environment, such as a room in a dwelling or other building. The occupancy grid 300 contains positions 310 of known occupied space representing the edges of objects, surfaces, and other obstructions within the real-world environment such as walls. In some examples, the occupancy grid 300 may comprise other information such as data related to the position of the mobile robot platform 320. Whilst four positions 310 are labelled in the occupancy grid 300 shown in FIG. 3A, in reality, there may be any number of positions contained within the occupancy grid 300 representing, for example, the locations of walls, surfaces, objects and obstructions within the real-world environment. Taken together these multiple positions in the occupancy grid 300 signify the edges of objects, surfaces and/or obstructions within the real-world environment indicated in the distance map. These positions are then used to generate the contours which are representative of paths in the real-world environment in which it is safe for the mobile robotic platform 320 to move without impinging on other positions. Other information may also be associated with the mobile robot platform 320 and stored in storage. Examples of such information include the positioning of servos, motors, hydraulics and/or pneumatic components of the mobile robot platform 320. This information may be used to position one or more armatures or other moveable components.

Given the nature of the real-world environment, and the fact that the mobile robot platform 320 is in a given location, areas within the real-world environment may not be visible by one or more sensors associated with the mobile robot platform, that are used to capture data representing the real-world environment. For example, in some areas, the view of one or more sensors may be obscured by one or more objects, such as object 360. Examples of such sensors will be described below with reference to FIG. 6. Based on the data captured, areas within the occupancy grid 300 may be categorised as one of:
known empty space 330, representing areas within the real-world environment where it is known that there are no objects, obstructions and/or surfaces;
known occupied space 310 as described above representing the edges of objects, obstructions and/or surfaces within the real-world environment; and
unknown space 340 representing areas within the real-world environment where the one or more sensors are unable to obtain data, for example based on a current field-of-view of the sensor at the location of the mobile robot platform 320.

A distance map 400 based on the occupancy grid 300 is generated at step 210. The distance map 400 represents areas within the real-world environment whereby the mobile robot platform 320 can move so that the sensors can obtain data regarding object(s), surface(s), and/or obstruction(s) represented in the occupancy grid 300 clearly. For example, the mobile robot platform 320 is able to position itself such that it is close enough to the object, surface and/or obstruction for the one or more sensors to be able to capture in-focus data regarding said object, surface, and/or obstruction. Positions, such as positions 410, 420, 430, are represented on the distance map 400 as areas surrounding the known occupied space 310 in the occupancy grid 300.

The positions 410, 420, 430 may be based on characteristics of the mobile robot platform 230 itself, for example, a clearance required for any locomotion components such as a wheel assembly, or in some examples, may be based on visibility characteristics of one or more sensors associated with the mobile robot platform 320. For example, a given sensor associated with the mobile robot platform 320 may have a set focal length. As such, the distance map 400 may represent areas within the occupancy grid 300 where the mobile robot platform 320 may move to a position, for example as close as possible but not touching objects, obstructions, and/or surfaces at a given locations, within the real-world environment. This enables the mobile robot platform 320 to accurately capture in-focus data of whatever object, obstruction, and/or surface is at a given location. Where the position is based on the visibility characteristics of more than one sensor, multiple positions 410, 420, 430 may be generated for each sensor, such that each sensor is able to obtain accurate in-focus data regarding the known occupied space 310 from the multiple sensors. In some examples, based on this distance, the distance map 400 may be refined, such that only positions within the real-world environment where the mobile robot platform 320 can capture accurate in-focus data are represented.

In some examples, the distance map 400 may be refined such that it represents areas of the occupancy grid that are known empty space 330 or unknown space 340. In yet further examples, the distance map may be refined such that it only includes areas which are known empty space 330. This may involve removing, from the distance map 400, areas categorised as unknown space 340 and/or known occupied space 310. This ensures that the distance map 400 includes at least areas which the mobile robot platform is able to traverse. However, it will be appreciated that removal of areas need not be undertaken, and other means of ensuring the mobile robot platform 320 does not enter unknown space when mapping the real-world environment may be used. Examples of this include the use of a location positioning system in combination with geofencing, which may be provided by a simultaneous location and mapping (SLAM) method performed by a SLAM module, as described below.

Following the generation of the distance map 400, at step 220, one or more contours are generated. The contours represent appropriate paths that a mobile robot platform 320 may follow, so as to avoid objects, obstructions and/or surfaces in the real-world environment. As mentioned above, the distance map 400 comprises positions 410, 420, 430 which represent a distance from known occupied space 310 identified within the occupancy grid. The positions 410, 420,430 may be based on a number of characteristics, and represent a location the mobile robot platform 320 in the real-world environment. This ensures that accurate data can be captured relating to the object, surface and/or obstruction in the real-world environment. As such, some of the positions 410, 420, 430 may fall within unknown space 340. It would, therefore, be undesirable to position the mobile robot platform 320 at such a position since it is unknown whether there is a surface, object and/or obstacle at that position. As such, one or more contours, such as contours 510, 520, 530, are generated based on the positions 410, 420, 430 as shown in FIG. 5A. The contours 510, 520, 530 represent portions of the position 410, 420, 430 that fall within known empty space 330. Accordingly, it is possible to move the mobile robot platform 320 to that location within the real-world environment without interacting with any of the objects, surfaces and/or obstructions.

Associated with each contour 510, 520, 530 is a start waypoint 510A, 520A, 530A. In some examples, the start waypoint represents a start waypoint of the contour 510, 520, 530 closest to the geographical location of the mobile robot platform 320 in the real-world environment. However, it will be appreciated that other methods for selecting a start waypoint 510A, 520A, 530A may be used. For example, the start waypoint 510A, 520A, 530A may be selected in accordance with other characteristics, such as determining whether the selected waypoint is on a blacklist of waypoints, such as the blacklist of waypoints described below, or based on the lengths of the path that the mobile robot platform 320 must traverse in order to reach the start waypoint 510A, 520A, 530A. It will be appreciated that the methodology for selecting a start waypoint may be based on a combination of methods, such as the above-mentioned closest methodology and the blacklist methodology. Following the selection of a start waypoint 510A, 520A, 530A, the contour 510, 520, 530 may be separated into a plurality of waypoints between the start waypoint 510A, 520A, 530A, and an end waypoint 510Z, 520Z, 530Z representing the furthest point on the contour 510A, 520A, 530A. This, therefore, represents a continuous route from the start waypoint 510A, 520A, 530A to the end waypoint 510Z, 520Z, 530Z. An example of the contours 510, 520, 530 being separated into a plurality of waypoints each with a start waypoint 510A, 520A, 530A and an end waypoint 510Z, 520Z, 530Z is shown in FIG. 5B. It will be appreciated that there are a number of methodologies for separating the contour into a plurality of waypoints. One such example may be to divide the contour 510, 520, 530 evenly, such that each waypoint is equidistant from another. This waypoint information may then be stored in association with the occupancy grid to enable easy and quick subsequent access during operations requiring the mobile robot platform to transit the waypoints.

Once the contours 510, 520, 530 have been generated and the waypoints determined, at step 230 of the mapping methodology 200, the waypoint information is used to navigate the mobile robot platform 320 to a waypoint in one of the contours 510, 520, 530. In some examples, this may be the start waypoint 510A, 520A, 530A associated with the contour 510, 520, 530. Navigating the mobile robot platform 320 to the waypoint may include initiating a locomotion-enabled component associated with the mobile robot platform 320. The locomotion-enabled component enables the mobile robot platform 320 to physically move the mobile robot platform 320 around the real-world environment in accordance with the occupancy grid 300 and the contours 510, 520, 530 generated. This is achieved by navigating the mobile robot system 320 to the start waypoint 510A, 520A, 530A of one of the contours 510, 520, 530, and then traversing the contour 510, 520, 530 by navigating to the next waypoint of the contour 510, 520, 530 until the end waypoint 510Z, 520Z, 530Z is reached. This will be described in further detail below with reference to FIG. 6.

At step 240 of the mapping methodology 200, the occupancy grid 200 is updated. This may occur at each waypoint or whilst navigating along the contours 510, 520, 530. This enables data to be captured using one or more sensors associated with the mobile robot platform 320, such that a more accurate representation of the real-world environment can be obtained. This is achieved, since areas of the real-world environment which were previously outside the field-of-view of the one or more sensors (that is, areas of unknown space 340) may now be within the field-of-view (and can thus be classed as either known occupied space 210 or known empty space 230) as the mobile robot platform 320 traverses the contours 510, 520, 530. The updating process may occur as each waypoint is visited by the mobile robot platform 320, and in other examples may occur at selected waypoints of the contour 510, 520, 530. In other examples, this may occur whilst navigating along a contour, for example at a waypoint and/or between waypoints. Alternatively, in yet further examples, the mobile robot platform 320 may traverse the entire contour 510, 520, 530, and perform the updating process when the end waypoint 510Z, 520Z, 530Z is reached. In some examples, the process can be repeated, such that new contours are determined enabling further exploration of the real-world environment, and further increasing the accuracy of the map and occupancy grid 300.

As the mobile robot platform 320 traverses along the contour 510, 520, 530 and visits the waypoints performing the update action described above, each waypoint visited may be added to a blacklist and the updated blacklist is then stored in storage. By recording the visited waypoints in this way, it can be tracked which waypoints have and have not been visited, and for which updated information has been obtained. This enables a start waypoint to be selected from the waypoints which are not contained within the blacklist, and for which updated information has not already been obtained. Furthermore, this enables the mapping process to be stopped and started as required whilst maintaining an understanding of the current progress of the mapping process.

As mentioned above in relation to steps 110 and 120 of method 100, during the exploration of the real-world environment by the mobile robot platform 320 and, whilst updating the occupancy grid 300, the data obtained by the one or more sensors may be analysed to identify objects within the real-world environment. By analysing the data and identifying objects therein, the mobile robot platform can obtain further information about the real-world environment and thereby generate a more accurate mapping of the locations of objects, surfaces and/or other obstructions. In some examples, information associated with the identity and/or representation of the objects may be stored as part of, or separately from, the occupancy grid, enabling subsequent access and analysis to be undertaken. In addition, the identity and/or representation of the object may be associated with its geographical location in the real-world environment.

### The System/Mobile Robot Platform

FIG. 6 shows a schematic representation of a system 600, such as the mobile robot platform 320 described above with reference to FIGS. 2 through 5B. The components of the system 610, 620, 630, 640, 650, 660 may be interconnected by a bus, or in some examples, may be separate such that data is transmitted to and from each component via a network.

The system 600 comprises at least one sensor 610A, 610Z for capturing information associated with the real-world environment. The one or more sensors 610A, 610Z may include a camera unit for capturing frames of image data representing the real-world environment. The camera unit may be a visual camera unit configured to capture data in the visible light frequencies. Alternatively, and/or additionally, the camera unit may be configured to capture data in the infra-red wavelengths. It will be appreciated that other types of camera unit may be used. In some examples, the camera unit may comprise multiple individual cameras each configured differently, such as with different lens configurations, and may be mounted in such a way as to be a 360-degree camera. In other examples, the camera unit may be arranged to rotate such that it scans the real-world environment, thereby increasing its field of view. Again, it will be appreciated that other configurations may be possible.

In addition to, or instead of, a camera unit, the at least one sensor 610A, 610Z may comprise a time of flight sensor unit or array distance sensor unit configured to measure the distance to/from the sensor unit to objects, surfaces and/or obstacles in the real-world environment. An example of such time of flight or array distance sensors includes laser imaging, detection, and ranging (LIDAR). Other time of flight and/or array distance sensors may also be used. In addition to detecting objects within the environment, the one or more sensors 610A, 610Z may also include an inertial measuring unit for measuring the movement of the mobile robot platform 320 around the real-world environment. The one or more sensors 610A, 610Z provide the captured data to a processor 620 for processing. The processor 630 is arranged to use the captured data to update the occupancy grid 300 accordingly, such that the occupancy grid 300 represents the real-world environment within the field-of-view of the one or more sensors 610A, 610Z.

The processor 620 is configured to perform at least the method 100 described above with reference to FIG. 1. The processor 620 comprises at least a mapping module 622 for mapping the real-world environment at a first time and at a second, subsequent, time based on the data obtained by the one or more sensors 610A, 610Z, as described above in relation to steps 110 and 120 of method 100. The mapping module 622 is configured to map the real-world location at a first and second, subsequent, time and identify objects within the real-world environment using a mapping methodology, such as the contour exploration methodology 200 described above with reference to FIGS. 2-5B.

A difference determination module 624 associated with the processor 620 is configured to analyse the first and second representations generated by the mapping module 622. In some examples, the system 600 comprises storage 630 which may include any type of storage medium such as a solid-state drive (SSD) or other semiconductor-based RAM; a ROM, for example, a CD ROM or a semiconductor ROM; a magnetic recording medium, for example, a floppy disk or hard disk; optical memory devices in general; etc. The storage 630 may be configured to store at least the first representation, and in some examples, and as explained above, the storage 630 may be configured to store characteristics associated with the mobile robot platform, such as the position of armatures and other moveable components, in addition to the identities and characteristics of objects within the real-world environment. Where the first representation is stored in the storage 630, the difference determination module 624 may obtain the first representation from the storage 630 and compare the first representation with the second representation to determine whether the geographical location of any of the objects is different as described above with reference to step 130 of method 100.

The processor 620 also comprises an actuation planning component 626 for determining instructions for a manipulator 640. The actuation planning component 626 provides instructions to control the manipulator 640 to move an object from the new position in the second representation to the initial position in the first representation. These instructions are provided to the actuation planning component 626 when it is determined by the difference determination module 624 that the object has been moved between the first time, being the time of the first representation, and the second time, being the time of the second representation.

As mentioned above, the system 600 also comprises an manipulator 640 for moving objects. The manipulator 640 may be a robotic system capable of manipulating different types of objects, such as a grabbing mechanism. However, it will be appreciated that other types of robotic platforms and manipulator 640 may be used.

In some examples, the system 600 may comprise a SLAM module 650 for locating the system 600 in the real-world environment. The SLAM module 650 may comprise several additional sensors and/or components such as a local positioning sensor. This may be used in combination with other sensors such as the inertial measuring sensor described above, and/or a satellite radio-navigation system. Examples of such satellite radio-navigation systems include the Global Positioning System, Galileo, or GLONASS. These sensors, either individually or together, are capable of tracking the location of the system 600 in the real-world environment the system 600 moves around the real-world environment. It will be appreciated that the SLAM module may comprise other components for performing these functions.

For moving the system 600 around the real-world environment, the system 600 may comprise a locomotion-enabled component 660 such as a wheel assembly, propellor assembly, or other controllable means for moving a mobile robot platform around the real-world environment. This not only enables the one or more sensors 610A, 610Z to capture data relating to areas of the real-world environment that were previously outside the field-of-view of the one or more sensors 610A, 610Z, but also allows the system 600 to move around the real-world environment to relocate objects which have been determined to be in the incorrect geographical location, to the correct geographical location.

At least some aspects of the examples described herein with reference to FIGS. 1-6 comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

1. A method for exploring a real-world environment using a mobile robot platform, the method comprising the steps of:
mapping the real-world environment at a first time, to generate a first representation of the real-world environment at the first time based on data obtained from at least one sensor associated with the mobile robot platform, and identifying an initial geographic location of an object in the first representation of the real-world environment;
mapping the real-world environment at a second time, later than the first time, to generate a second representation of the real-world environment at the second time based on data obtained from the at least one sensor associated with the mobile robot platform, and identifying a new geographic location of the object in the second representation of the real-world environment;
determining a difference between the initial geographic location of the object and the new geographic location of the object; and
using a manipulator associated with the mobile robot platform to move the object to the initial geographic location in the real-world environment when it is determined that the initial geographic location of the object differs from the new geographic location of the object.

2. The method according to claim 1, wherein mapping the real-world environment at the first time and mapping the real-world environment at the second time, comprises identifying at least one of:
a surface within the real-world environment on which the object is placed; and
a storage receptacle in the real-world environment containing the object.

3. The method according to claim 1, wherein mapping the real-world environment at the first time and mapping the real-world environment at the second time comprises analysing the data obtained from the at least one sensor associated with the mobile robot platform using at least one of a frontier exploration methodology and a contour exploration methodology.

4. The method according to claim 1, wherein mapping the real-world environment at the first time comprises analysing the data obtained from the at least one sensor associated with the mobile robot platform to identify and classify the object in the first representation.

5. The method according to claim 4, wherein the classification of the object in the first representation is based on a database of known objects retrieved from storage associated with the mobile robot platform.

6. The method according to claim 4, wherein identifying and classifying the object comprises analysing the data obtained from the at least one sensor using a machine learning methodology.

7. The method according to claim 4, comprising determining whether the object is a moveable object based on the classification of the object, and when it is determined that the object is not a moveable object, flagging said object in the first representation as immoveable.

8. The method according to claim 1, comprising storing at least the first representation of the real-world environment in storage associated with the mobile robot platform.

9. The method according to claim 1, wherein mapping the real-world environment at the first time and at the second time includes determining a pose of the object in the respective representation of the real-world environment, and, wherein, using the manipulator to move the object to the initial geographic location in the real-world environment includes restoring a pose of the object to that at the first time.

10. The method according to claim 1, wherein using the manipulator associated with the mobile robot platform to move the object to the initial geographic location in the real-world environment is performed when it is determined that the initial geographic location of the object differs from the new geographic location of the object by more than a threshold amount.

11. A system for exploring a real-world environment, the system comprising:
at least one sensor to capture information associated with the real-world environment;
a manipulator to move an object in the real-world environment; and
at least one processor arranged to:
map the real-world environment at a first time, to generate a first representation of the real-world environment at the first time based on data obtained from the at least one sensor, and identify an initial geographic location of the object in the first representation of the real-world environment;
map the real-world environment at a second time, later than the first time, to generate a second representation of the real-world environment at the second time based on data obtained from the at least one sensor, and identify a new geographic location of the object in the second representation of the real-world environment;
determine a difference between the initial geographic location of the object and the new geographic location of the object; and
control the manipulator to move the object to the initial geographic location in the real-world environment when it is determined the initial geographic location of the object differs from the new geographic location of the object.

12. The system according to claim 11, comprising a locomotion-enabled component for navigating to a given geographical location in the real-world environment, wherein the given geographical location is associated with at least one of the initial geographic location of the object and the new geographic location of the object.

13. The system according to claim 11, comprising storage for storing at least the first representation of the real-world environment.

14. The system according to claim 11, wherein the manipulator comprises a robotic system for manipulating the object.

15. The system according to claim 11, wherein the at least one sensor for capturing information associated with the real-world environment comprises at least one of:
a camera unit;
a time of flight sensor unit;
an array distance sensor unit; and
an inertial measuring unit.

16. The system according to claim 11, wherein the at least one sensor is a moveable sensor configured to scan the real-world environment to increase the field-of-view of the at least one sensor.

17. A non-transitory computer-readable storage medium comprising a set of computer-readable instructions stored thereon which, when executed by at least one processor are arranged to control a mobile robot platform to explore a real-world environment, wherein the instructions, when executed, cause the processor to:
map the real-world environment at a first time, to generate a first representation of the real-world environment at the first time based on data obtained from at least one sensor associated with the mobile robot platform, and identifying an initial geographic location of an object in the first representation of the real-world environment;
map the real-world environment at a second time, later than the first time, to generate a second representation of the real-world environment at the second time based on data obtained from the at least one sensor associated with the mobile robot platform, and identifying a new geographic location of the object in the second representation of the real-world environment;
determine a difference between the initial geographic location of the object and the new geographic location of the object; and
use a manipulator associated with the mobile robot platform to move the object to the initial geographic location in the real-world environment when it is determined that the initial geographic location of the object differs from the new geographic location of the object.
